(19) United States
(12) Patent Application Publication
(10) Pub. No.: US 2021/0392401 A1
(43) Pub. Date: Dec. 16, 2021

(54) ELECTRONIC DEVICE, METHOD AND PROGRAM FOR DERIVING VIEWING PATTERNS AND PREDICTING ACTIONS BASED ON PROXIMITY OF USERS

(71) Applicant: ARRIS Enterprises LLC, Suwanee, GA (US)

(72) Inventors: Sandeep Guddekoppa SURESH, Bangalore (IN); Vinod JATTI, Bangalore (IN)

(21) Appl. No.: 17/324,509

(22) Filed: May 19, 2021

Related U.S. Application Data
(60) Provisional application No. 63/039,099, filed on Jun. 15, 2020.

(51) Int. Cl. H04N 21/45; H04N 21/41; H04N 21/466; H04N 21/442; H04N 21/422

(52) U.S. Cl. CPC H04N 21/4532; H04N 21/4126; H04N 21/42203; H04N 21/44218; H04N 21/4667

(57) ABSTRACT

An electronic device includes a processor a memory having software stored thereon. The processor may be configured to execute the software to at least cause the electronic device to: determine if at least one user is in proximity to the electronic device; automatically determine user preference information associated with the at least one user over time from multimedia content selected when the at least one user is in proximity to the electronic device; derive a viewing pattern map of preferred multimedia content based on the user preference information; and perform a background launch operation of the preferred multimedia content of the at least one user based on the viewing pattern map. Actions may be predicted according to user proximity and preferred multimedia content.

### BACKGROUND

Electronics manufacturers, cable service providers, and multiple system operators (MSOs) strive to provide products that are convenient for customers to use. Convenient features can differentiate products on the market and drive demand for products of a certain manufacturer.

A popular electronic device in many homes is the so-called “set-top-box” (STB), which houses electronic circuits that convert signals from an input line into signals usable by consumer devices for displaying data and audio/video (A/V) media content such as television programing and movies.

The types of consumer devices being served by STBs will become more varied, including not only televisions, but computers, and portable devices such as electronic tablets and smart phones, and wearable electronics such as smart watches. The input signals can be provided by service providers including cable television providers, satellite television providers, internet service providers, and multiple system operators. The STB can be connected to consumer devices by HDMI® or the like, and make use of features such as HDMI-CEC.

In addition to being provided in a self-contained STB configuration, the electronics can be integrated directly into a consumer device, such as being built into a television. For ease of discussion, the STB configuration will be referred to hereafter, but the invention is not intended to be limited only to STBs, and can be utilized on any type of consumer electronic device that displays data and A/V media content such as television programing and movies.

To determine convenient features for use of an STB, it is necessary to analyze a user's interaction with and usage of the STB.

In addition to basic cable television functions and/or Internet Protocol Television (IPTV) functions, the STBs disclosed herein may include computer network connectivity functions, including Local Area Network (LAN) interfaces, and Wireless Local Area Network (WLAN) interfaces which use wireless signals, such as Wi-Fi or in-home LTE (Long Term Evolution) technology, or the like.

For ease of installation and maximization of potential locations in the home, the STBs disclosed herein are not required to be connected to the home network via a wired connection, but rather may exclusively use a Wi-Fi connection.

The STB can provide access to content broadcast on a broadcast channel, content provided through an over-the-top (OTT) service, content provided through a pay-per-view service, and content provided through a video-on-demand (VOD) service.

The STBs disclosed herein may include applications that provide access to additional media content or media services. Examples of such applications and/or media services include Netflix®, YouTube™, Amazon Prime, or the like.

Service providers typically utilize an Electronic Program Guide (EPG) for presenting channel information to users. An EPG is an on-screen guide to a broadcast schedule for television programs. A user can navigate and select content to watch by categories including but not limited to channel, time, and title, by use of a remote control, a keyboard, or other input devices (e.g., mobile devices such as smart phones and tablets).

An EPG typically includes a Graphical User Interface (GUI) for displaying program start/end times, channel identification, alternative program accessibility (e.g., from Pay-Per-View (PPV) and/or VOD services) and other descriptive information. EPGs are typically sent within a transport stream of a television station or created based on data in a dedicated data channel.

Users in the same home often have different viewing preferences. Accordingly, if the last user stops watching a TV and a new user starts viewing that TV, the STB frequently is not set to display the content that the current user desires, because the STB is simply left on the content that was most recently watched. Thus, the current user typically has to manually close the previous session and tune to the desired channel, which is inconvenient for the current user.

Additionally, instead of tuning to a particular channel, a new user may instead desire to use a particular video service or video streaming application included with the STB. However, the new user must manually open the OTT service to begin watching the content of the OTT service.

With the existence of multiple OTT accounts on the same devices, it is possible for privacy to be violated. OTT accounts can service multiple logins and enable switching therebetween. If the last user forgets to log out, then a new viewer can watch personalized content belonging to the last user.

As another example, a user may watch one kind of program when he is alone or with a certain set of users. If any other user or any user outside this certain set starts watching TV, he or she will have to manually change the program and will likely find out what was previously being watched.

Furthermore, when a user watches a program alone or in the company of a certain set of users, an OTT service may display some suggestions. These suggestions may not be appropriate in the presence of any other user or in the presence of a user who does not belong to the certain set. This represents another way privacy can be compromised.

In addition, existing solutions cannot detect if individual users are in or out of proximity and therefore cannot tailor automatic actions based upon such detection.

Due to these drawbacks of existing technologies, there is a need to derive a viewing pattern map of preferred multimedia content for users to enable automatic smart actions by an electronic device.

### SUMMARY

The present application discloses an electronic device, method and program for deriving a viewing pattern map of preferred multimedia content for users to enable automatic smart actions by tracking the presence of users.

The electronic device can include: a processor; and a memory having software stored thereon, wherein the processor is configured to execute the software to at least cause the electronic device to: determine if at least one user is in proximity to the electronic device; automatically determine user preference information over time from multimedia content selected when the at least one user is in proximity to the electronic device; derive a viewing pattern map of preferred multimedia content based on the user preference information; and perform a background launch operation of at least one instance of a preferred multimedia content of the at least one user based on the viewing pattern map. This can include opening a service (e.g., an OTT service) in connection with the preferred multimedia content of the at least one user using the credentials of the at least one user.

The electronic device can be connected to a display device, and the display device can be configured to display the current content to be output from the electronic device.

The processor can be configured to execute the software to cause the electronic device to determine if at least one user is in proximity to the electronic device by at least one of presence of a mobile device of the at least one user, voice recognition of the at least one user or the mobile device of the at least one user, or face recognition of the at least one user.

When at least one user is in proximity to the electronic device, user preference information is automatically determined over time from user-selected multimedia content information. Techniques presented in the present disclosure provide a way to track/accumulate at least one user's viewing history and automatically determine the at least one user's preferences/habits. A viewing pattern map of preferred multimedia content is derived based on the automatically detected user preference information.

Automatic smart actions can be performed by the electronic device based on the viewing pattern map. For example, a user prompt may be generated for display on a display device when a first user moves out of proximity of the electronic device. The user prompt may display viewing options for the preferred multimedia content of a second user who is still in proximity to the electronic device. In addition, the processor can be configured to perform a background launch operation of the preferred multimedia content of the second user in advance of generation of the user prompt. This can include opening a service (e.g., an OTT service) in connection with the preferred multimedia content of the second user using the credentials of the second user.

In view of the above, user convenience is increased, as the current user does not have to manually tune to the desired channel. Likewise, a service can be automatically launched, so that the current user does not have to manually open the service.

### BRIEF DESCRIPTION OF THE DRAWINGS

FIG. 1 illustrates an example network environment in accordance with implementations of various techniques described herein.

FIG. 2 is a block diagram of an electronic device according to the present invention.

FIG. 3 is a flowchart of an algorithm implemented by the electronic device for deriving viewing pattern map(s) and predicting, recommending and/or executing actions based on the viewing pattern map(s).

FIG. 4 is a table illustrating watching habits of a group of users and derived viewing pattern maps.

FIG. 5 is a table illustrating movement of mobile devices and predicted and/or recommended actions.

### DETAILED DESCRIPTION

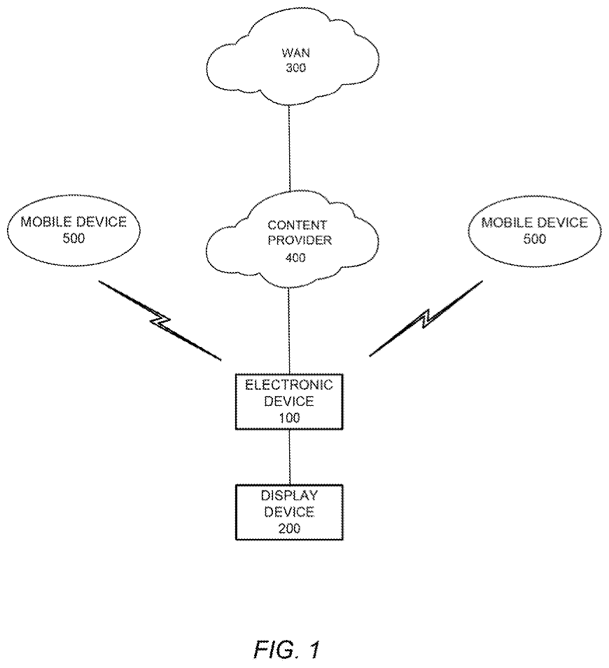

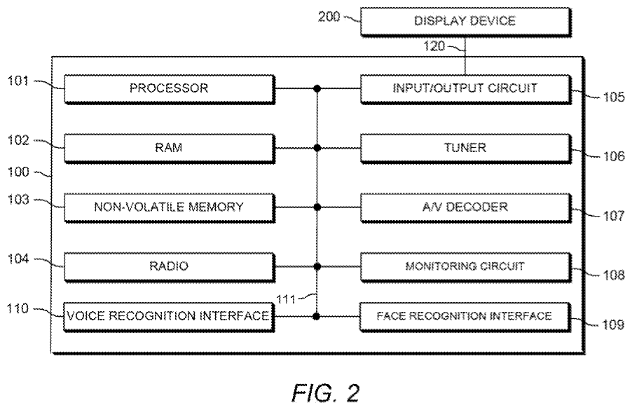

FIG. 1 is a block diagram illustrating an example network environment 100 for determining viewing patterns based on proximity of users. In some implementations, video, voice, and/or data services may be delivered to one or more mobile devices 500 via one or more customer premises equipment (CPE) devices installed within a user premises. For example, multiple services may be provided by an electronic device 100 (e.g., an STB) and may be received by a user through a display device 200 (e.g., a TV). It should be understood that a user may receive multiple services through other display devices such as a mobile device, tablet, computer, gaming console, and others. The various data, multimedia, and/or voice services provided by the STB 100 may include, but is not limited to, live or broadcast television, VOD content, pay-per view content, recorded content (e.g., digital video recorder (DVR) content), audio-only content, streaming content, and others. The STB 100 may receive content from multiple different networks and/or service providers and store this content in a memory 103 (as shown in FIG. 2). In one implementation, STB 100 may act as a digital media server in a DLNA-based network. In another implementation. STB 100 can be a DVR or any other multimedia device capable of providing DVR-like functionality.

Multiple services may be delivered to CPE devices over one or more local networks. For example, a local network may be provided by a gateway device, and the multiple services may be delivered to one or more CPE devices by the gateway device.

Local network(s) may include a coaxial network, a LAN, WLAN, personal area network (PAN), Multimedia over Coax Alliance (MoCA) network, mobile hotspot network, and others. It should be understood that the STB 100 may receive services from and may output upstream communications to an access point (AP)(e.g., gateway device, modem, router, wireless extender, etc.) over a wired or wireless connection to the AP.

Multiple services may be delivered to a user premises from a wide-area network (WAN) 300 through a content provider 400. The content provider 400 may include, for example, a hybrid fiber-coaxial (HFC) network, fiber network, mobile network, satellite network, and any other network operable to deliver services to a user premises.

Multimedia content may be received at the STB 100 as a content stream. For example, the content may be delivered to the STB 100 as a stream of packets or frames, and the packets or frames may be decoded and processed for presentation to a user through a connected TV 200.

The STB 100 may be configured to receive content from a plurality of content or service providers 400. For example, the STB 100 may receive content from a plurality of different content providers 400 (e.g., a head end of a cable network, satellite network, etc.) and/or WANs 300. Content streams received from different service providers may be received at the STB 100 in different formats.

An electronic device according to the present invention, e.g., an STB 100, is shown in FIG. 2. The electronic device includes circuitry by which the electronic device can control access to and display of content. For ease of discussion, the electronic device will be explained in the configuration of an STB hereafter, but the invention is not intended to be limited only to STBs and can alternatively be integrated directly into a consumer device such as a display device (e.g., television), computer, or any other consumer device, such as electronically equipped appliances.

The STB 100 includes bus lines 111 through which various elements are connected and communicate data with each other. A processor 101, which can be a dedicated control circuit, CPU, microprocessor, etc., controls the circuits of the STB 100. RAM 102 can be provided as a working memory for the processor 101, and a non-volatile memory 103 can be provided for storage of program code, and user A/V content and other data.

A radio 104, such as a Wi-Fi WLAN interface radio transceiver, or an in-home Long Term Evolution (LTE) transceiver outputs the signal of the selected channel to a wireless user device. The wireless output by the radio 104 can be in place of or in addition to the wired output by an input/output circuit 105. The STB 100 can output the signals of respective selected channels to plural devices simultaneously, and otherwise wirelessly communicate with the plural devices simultaneously. Also, the STB can access Internet Protocol Television (IPTV) and/or internet-based media video services such as Netflix® by way of connecting the STB 100 to the Internet using an Internet connection provided by the radio 104.

The radio 104 also receives command and control messages, including code downloads and software updates, sent from the service provider.

The STB 100 may include the input/output circuit 105, which can include one or more connectors, such as RF connectors or Ethernet connectors. One of the connectors of the input/output circuit 105 can be connected to a content provider 400, such as an MSO, by terrestrial antenna, satellite dish, or wired cable. Through the input/output circuit 105, the STB 100 receives an input signal, including data and/or A/V content, from the content provider 400 and can send data to the content provider 400.

The STB 100 can function as a gateway, maintaining communication with the content provider, for example, via a DOCSIS (Data Over Cable Service Interface Specification) connection.

The STB 100 can include a tuner 106 to select a desired channel from the input signal based on an input instruction by the user either through a button or buttons (not shown) on the STB 100, via a remote control (not shown) of the STB 100, or via a user device (not shown) such as a computer, electronic tablet device, or mobile phone 500. Channel information can be retrieved from an EPG (not shown) of the STB 100.

In order to allow an installation of the STB 100 in a manner in which no physical cable input is required, the input signal from the service provider can be received by a separate electronic device, such as a cable modem, or a different STB, and the signal can be communicated to the STB 100 wirelessly via the radio 104. In such a scenario, the STB 100 could be provided without the input/output circuit 105. Also, the STB 100 can provide the content according to IPTV, in which can the tuner 106 may be omitted as well.

The signal of the selected channel is decoded by an A/V decoder 107. The input/output circuit 105 can also include a connector 120 that is to be connected to the TV 200, for displaying A/V content received by the STB 100 and decoded by the A/V decoder 107.

The STB 100 can include a monitoring circuit 108, which can monitor the usage of the STB 100. For example, the monitoring circuit 108 can monitor and acquire information pertaining to the time and day that certain channels are viewed and/or when services such as VOD are used and which user or users are associated with the channel viewership or service usage. A table can be generated by the monitoring circuit 108 that stores such information. The information in this table can be updated as the watching habits of a user are monitored during everyday usage of the STB 100. The table is stored in a database of the STB 100.

The processor 101 collects a watch history, e.g., information regarding user-selected multimedia content, over time. This watch history information may be collected from any associated device on which a user views content, e.g., STB 100.

The processor 101 automatically determines user preference information over time. The processor 101 determines the user preference information from user-selected multimedia content information, e.g., the watch history. The processor 101 identifies preferred multimedia content based on the automatically detected user preference information.

The user preference information may include tuning data associated with the multimedia content, e.g., channel information. The user preference information may also include metadata or any other data associated with the multimedia content. In one implementation, the metadata is collected at a headend and provided to the STB 100. In another implementation, the metadata is collected at STB 100.

The metadata may include content information, e.g., any information related to the content. Examples of content information include program information, e.g., a title of a program and/or a description of a program. Examples of content information may also include cast information, genre information, and/or programming similar to the user-selected multimedia content.

The monitoring and acquiring of information pertaining to the usage of the STB 100 by the monitoring circuit 108 begins when the processor 101 detects that each of the STB 100 and the TV 200 is on and at least one user is in proximity to the STB 100.

The processor 100 can determine if at least one user is in proximity to the electronic device by at least one of presence of a mobile device 500 of the at least one user, voice recognition of the at least one user or the mobile device 500 of the at least one user, or face recognition of the at least one user.

Presence of a mobile device 500 of the at least one user can be detected by a communication link between the STB 100 and the mobile device 500 being established. The mobile device may be, for example, a tablet, a smart phone or a wearable device such as a smart watch (e.g., Apple Watch®) or activity tracker (e.g., Fitbit®). The STB 100 may be equipped for wireless communications and may be configured to communicate with the mobile device 500. For example, the STB 100 and the mobile device 500 may be paired or associated through a network such as a wired LAN, a wireless LAN (WLAN)(e.g., Wi-Fi), Bluetooth connectivity, etc. When a mobile device 500 is in proximity to the STB 100 (e.g., a user returns home), the STB 100 and the mobile device 500 establish communications therebetween. In other words, the STB 100 may detect proximity of the mobile device 500 based on a connection request from the mobile device 500 or connectivity to the mobile device 500. In some variations, the signal quality between the mobile device 500 and the STB 100 may be used to determine proximity. Signal quality can be ascertained by determining whether the strength of a signal is at or above a threshold level.

In other variations, if the STB 100 does not have wireless capability, the STB 100 can get help from the nearest in-home wireless device (such as a Wi-Fi AP) to track mobile device movement and derive a viewing pattern map.

The users within the residence are likely to have more than one mobile device 500 and even a single user may have multiple mobile devices 500. The STB 100 may be configured to receive information from more than one mobile device 500. According to one embodiment, the STB 100 may be configured to receive and organize information for more than one user. When the STB 100 is linked to the mobile devices 500 and the STB 100 is configured to derive at least one viewing pattern map for the mobile devices 500, each of the mobile devices 500 may be associated with a particular user. For example, each mobile device 500 may be identified by its Media Access Control (MAC) address.

User profiles or preferences can be created based on the presence of the mobile devices 500. The users may be identified, for example, as generic users (e.g., User 1, User 2), family member (e.g., mom, dad, child) and/or by name. The mobile devices 500 may be identified by number and type and/or by name. All, or a subset or the viewing pattern map derivation, may be performed per user. The user watching the TV 200 may be determined by determining which mobile device 500 is in proximity to the STB 100. Once the user is determined, the viewing pattern map for that user may be derived. If more than one user is watching the TV 200 based on a determination that more than one mobile device 500 is in proximity to the STB 100, an aggregate viewing pattern map for all or a subset of the users may be derived. As the pattern of a user is subject to the presence of other users, multiple profiles can be created for a single user or various group profiles can be created on the basis of the presence of different users as there is always a dynamism created by the presence or absence of different users. These can be represented in the viewing pattern maps which can be applied to OTT streaming services.

Example profile possibilities include a first profile for a user who watches a particular set or kind of content when alone, a second profile for the same user who watches a different set of programs in the company of others, and various combinations thereof for and with additional users.

Static devices like microwave ovens, fixed routers, etc. may be ignored as their presence might not impact viewing patterns or profiles. By tracking the movement of mobile devices 500 and comparing such movement with activities performed in the STB 100, over a period, mapping or correlation between the mobile devices 500 and the STB 100 can be established. This can be accomplished using identified mobile devices 500 even if exact details about family members and their relationship are not known.

The STB 100 may include a face recognition interface 109 having one or more cameras (for e.g., gesture and/or presence recognition, and/or video telephone communication), and associated programming. Accordingly, users can be determined to be in proximity to the STB 100 by face recognition by the STB 100. In some implementations, it is contemplated by the present disclosure that the face recognition interface 109 could be omitted from the STB 100.

The STB 100 may include a voice recognition interface 110 having one or more of far-field microphones, (for e.g., voice command and/or presence recognition, and/or telephone communication), speakers, and associated programming. Embodiments of the STB 100 may be programmed to output and recognize voice commands and implement controls of the mobile devices 500 based on the voice commands. The voice commands can be commands to execute particular actions such as service discovery requests and device capability queries. In other words, the STB 100 and the mobile devices 500 can have a shared voice vocabulary and can pair with and/or communicate with each other through voice communication. Accordingly, the users can be determined to be in proximity to the STB 100 by voice interaction between the STB 100 and the mobile devices 500. Alternatively, a user can be determined to be in proximity to the STB 100 by voice interaction between the STB 100 and the user himself or herself. In some implementations, it is contemplated by the present disclosure that the voice recognition interface 110 could be omitted from the STB 100.

If the processor 101 detects that each of the STB 100 and the TV 200 is on and at least one user is in proximity to the STB 100, the processor 101 sends a control signal, using bus lines 111, to the monitoring circuit 108 to begin monitoring usage of the STB 100.

Once the control signal is sent, the monitoring circuit 108 monitors a usage of the STB 100, and stores data, in the form of user preference information, in a table in a memory of the STB 100. The memory can be RAM 102 or non-volatile memory 103, a separate flash-type memory of the STB 100, or in the form of cloud storage accessible to the STB 100, or any future storage medium. The table is stored in a database stored in the memory of the STB 100.

The processor 101 will refrain from transmitting a control signal to the monitoring circuit 108 to begin monitoring usage of the STB 100 if: (i) the STB 100 is determined to be off, (ii) the TV 200 is determined to be off; or (iii) no user is in proximity to the STB 100, thereby avoiding unnecessary operation of the monitoring circuit 108.

The STB 100 can predict, recommend, and/or execute next user actions based on the viewing pattern maps. For example, the processor 100 can generate a user prompt for display on the TV 200 whereby the user prompt can display viewing options for the preferred multimedia content of the user. The user prompt may be generated when one user moves out of proximity of the STB 100 and viewing options for the preferred multimedia content of another user can be displayed.

In anticipation of the user's acceptance of the recommended action, background hidden activity can be launched which performs operations like service acquisition, graphics content to be rendered, etc. In other words, the processor 100 can perform a background launch operation of the preferred multimedia content of the user in advance of generation of the user prompt. For example, if the user is predicted to watch OTT content such as Netflix®, then background activity can launch the OTT service in a background mode so as to be ready to use. If the user accepts the recommended action, the OTT service is brought to the foreground. In this way, initial launch times are reduced and user convenience is enhanced. In an exemplary implementation, the non-volatile memory 103 may contain a script or batch file associated with a triggered event of a particular action being recommended. Upon occurrence of the triggered event, the script or batch file runs a utility which makes an HTTP request to the server of the content provider 400 for access to the preferred multimedia content that has been recommended and starts a daemon (i.e., a computer program that runs as a background process) for the purpose of handling a service request of launching the preferred multimedia content that is expected to be received after the recommended action. Upon receiving input at the user prompt of the user's acceptance of the recommended action, the OTT service (e.g., Netflix®) in connection with the preferred multimedia content of the user is brought to the foreground.

With personalized content provider accounts such as OTT accounts including Amazon Prime, Netflix®, etc., users expect privacy and might not wish to share content or suggested programs with other users. Even though a user has not specifically logged out of his or her content provider account, the processor 100 can automatically log the last user out of his or her content provider account when the last user moves out of proximity of the STB 100. In an exemplary implementation, the non-volatile memory 103 may contain a script or batch file associated with a triggered event of the signal strength of the mobile device 500 of a logged-in user falling below a threshold level. Upon occurrence of the triggered event, the script or batch file performs the logout automatically for the user by running a utility which makes an HTTP request to the server of the content provider 400 for logout. Accordingly, the privacy of the last user can be protected. Similarly, the processor 100 can automatically record the preferred multimedia content of a user when the user is not in proximity to the STB 100 or moves out of proximity of the STB 100. For example, every Saturday evening all family members may watch a popular cable comedy show. If one of the family members is determined to be absent (i.e., out of proximity of the STB 100) when this show is watched on Saturday evening, the STB 100 may automatically record the show for later watching by the absent family member. Accordingly, the next time the family member who was absent is individually watching the TV 200, the STB 100 can notify this family member about the recorded show.

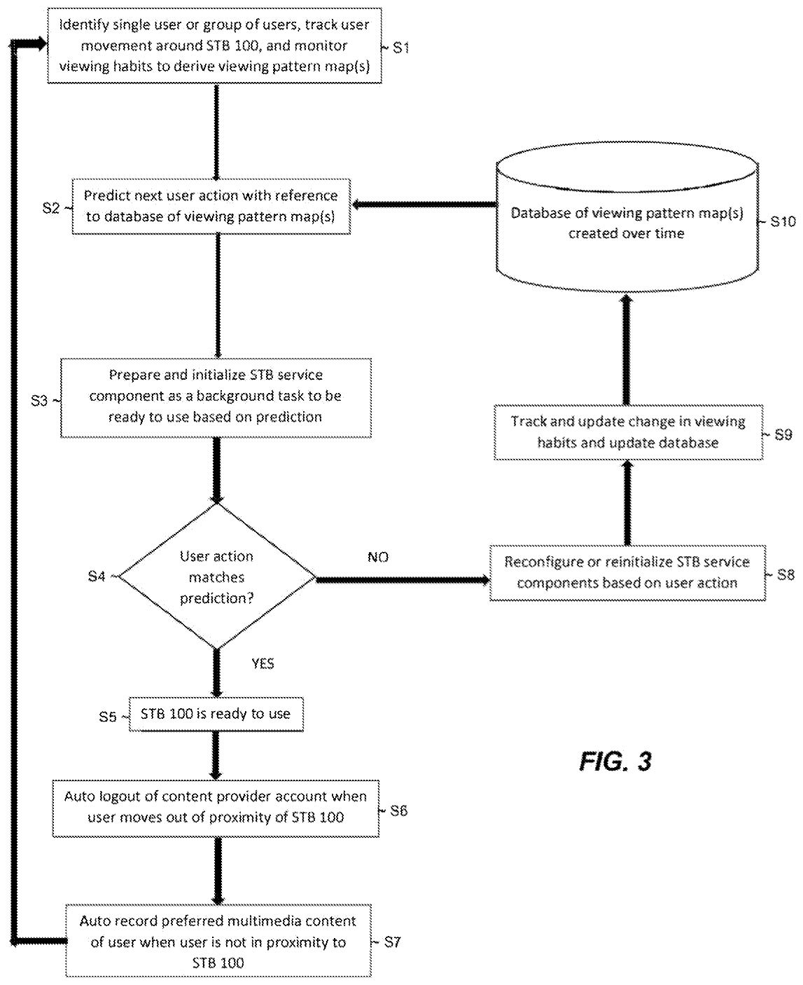

FIG. 3 is a flowchart of an algorithm implemented by the electronic device for deriving viewing pattern map(s) and predicting, recommending and/or executing next user actions based on the viewing pattern map(s).

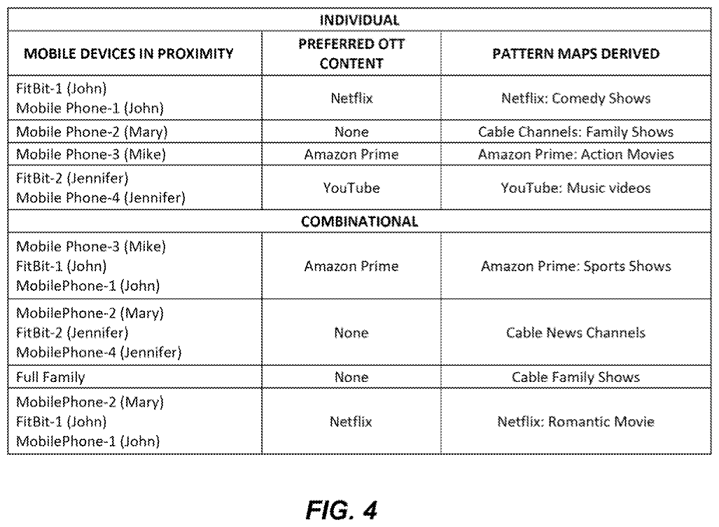

In Step S1, if the processor 101 determines that a user is in proximity to the STB 100, the processor 101 sends a control signal to the monitoring circuit 108 to begin monitoring usage of the STB 100. A table is generated by the monitoring circuit 108. Automatically detected user preference information is extrapolated and accumulated into the table that is stored, for example, in RAM 102. The table is generated in a database of the STB 100, and serves to tabulate, for example, when a particular channel or service is watched on a particular day or span of days. However, the table can include other cumulative information such as frequency of access and the like. A viewing pattern map of preferred multimedia content is derived based on the automatically detected user preference information. The derivation of the viewing pattern map will be explained in further detail below with respect to FIG. 4.

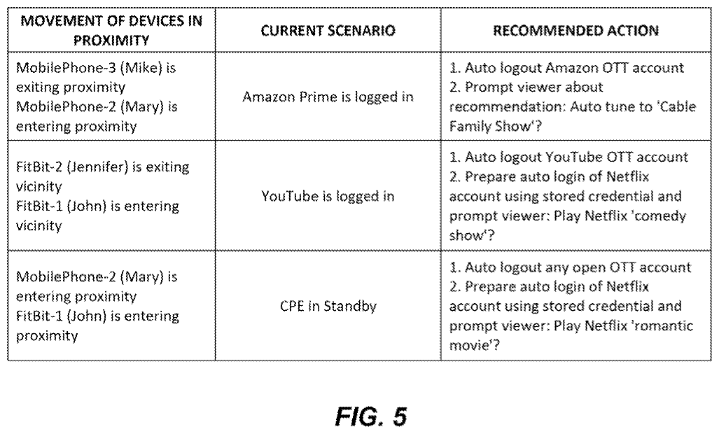

In Step S2, the processor 101 uses the viewing pattern map to predict next user actions (e.g., watching a particular show in an OTT service) based on the user's viewing habits and preferred multimedia content. The prediction of actions will be explained in further detail below with respect to FIG. 5.

In Step S3, the processor 101 prepares and initializes a service (e.g., launching the OTT service in the background) of the STB 100 in anticipation of the prediction.

In Step S4, it is determined if the user action matches the prediction.

If the user action matches the prediction in Step S4, the STB 100 is ready to use in Step S5 and the user can accept any prompt and watch the preferred multimedia content.

In Step S6, if the last user moves out of proximity of the STB 100 and has not logged out of his or her content provider account, the processor 100 can automatically log out of the content provider account.

In Step S7, the processor 100 can automatically record the preferred multimedia content of the last user after he or she moves out of proximity of the STB 100. The process then returns to Step S1.

If the user action does not match the prediction in Step S4, STB service components are reconfigured or reinitialized in Step S8 based on the nonmatching user action.

In Step S9, data of the preferred multimedia content is constantly updated as the user uses the STB 100, and the viewing pattern map(s) are updated accordingly. Since the monitoring circuit 108 monitors usage when at least one user is in proximity to the STB 100, new user preference information is constantly acquired when at least one user is in proximity to the STB 100, and watching habits of the user(s) can effectively be learned.

In Step S10, the processor 101 reads the viewing pattern map(s) stored in the table. This information includes updated preferred multimedia content representing the latest user watching habits. The updated database is relied upon the next time Step S2 is performed.

FIG. 4 is a table illustrating watching habits of a group of users and derived viewing pattern maps.

Within a home, different family members may be subscribed to different OTT services and preferences of watching OTT services or cable programs or popular family shows may differ based on whether a particular family member is watching alone or with other family members.

For example, in a family including John, Mike, Mary and Jennifer: John's preferred multimedia content when alone is Netflix®; Mike's preferred multimedia content when alone is Amazon Prime; Mary's preferred multimedia content when alone is regular cable operator channels, and Jennifer's preferred multimedia content when alone is YouTube™. However, the preferred multimedia content of a combination of Mike and John is Amazon Prime, the preferred multimedia content of a combination of Mary and Jennifer is cable news channels, the preferred multimedia content of a combination of John, Mike, Mary and Jennifer is cable family shows, and the preferred multimedia content of a combination of Mary and John is a romantic movie on Netflix®. Accordingly, individual or group profiles can be created and viewing pattern maps can be derived therewith. Smart actions can be predicted, recommended and/or executed based on the viewing pattern maps.

FIG. 5 is a table illustrating movement of mobile devices and predicted and/or recommended actions.

When a user moves out of proximity of the STB 100, the signal strength of the user's mobile device 500 gradually diminishes. Once the signal strength falls below a threshold level, the user can be considered to be out of proximity of the STB 100. Similarly, by detecting connection or threshold signal strength of another mobile device 500, a next user can be identified. Based on whether the STB 100 is in a standby mode or an active mode, a recommended action can be prompted to the next user with reference to the table of FIG. 4, for example. Example recommended actions are shown in the table of FIG. 5.

In the first example, Mike's mobile phone is exiting the proximity of the STB 100 and Mary's mobile phone is entering the proximity of the STB 100. Accordingly, the STB 100 can automatically log out of Mike's Amazon Prime account and prompt Mary if she would like to tune to a cable family show which is her preferred multimedia content when watching alone.

In the second example, Jennifer's Fitbit® is exiting the proximity of the STB 100 and John's Fitbit® is entering the proximity of the STB 100. Accordingly, the STB 100 can automatically log out of Jennifer's YouTube™ account, initially launch Netflix® in a background mode using John's credentials, and prompt John if he would like to play a Netflix® comedy show which is his preferred multimedia content when watching alone.

In the third example, Mary's mobile phone and John's Fitbit® are simultaneously entering the proximity of the STB 100. Accordingly, the STB 100 can automatically log out of any open OTT account, initially launch Netflix® in a background mode using Mary's or John's credentials, and prompt Mary and John if they would like to play a Netflix® romantic movie which is their preferred multimedia content when watching together.

The present invention provides user convenience by automatically tuning to a channel or opening a service, after learning the user's watching habits through monitoring of the user's access to content on the STB.

As mentioned above, various components shown in FIG. 2 can be included or omitted in each electronic device. For example, in the example above, the STB 100 can be an STB configured to omit the input/output circuit and the tuner, in which case the STB would be of a wireless only IPTV configuration with no wired connection to the gateway apparatus, such as a modem or other STB, and no wired connection to the user display device, such as a television. In such a case, all content and data is communicated wirelessly via the radio. Alternatively, components such as the tuner and input/output circuit can be retained, but their functions not utilized in a wireless only IPTV implementation.

The present invention can be implemented not only as a device(s), but also as a method(s) including the steps conducted by the electronic device(s) as discussed above, which method(s) as discussed above constitute examples of algorithms. The invention can also be implemented as a program on a non-transitory computer-readable recording medium for causing a computer, such as a processor in an electronic device, to execute such steps. The non-transitory computer-readable recording medium could be, for example, a CD-ROM, DVD, Blu-ray Disc™, or an electronic memory device.

The present invention may be implemented as any combination of a system, a method, an integrated circuit, and a computer program on a non-transitory computer readable recording medium.

The processor and any other parts of the electronic device may be implemented as Integrated Circuits (IC), Application-Specific Integrated Circuits (ASIC), or Large Scale Integrated circuits (LSI), system LSI, super LSI, or ultra LSI components which perform a part or all of the functions of the electronic device, such as STBs. Each of the parts of the present invention can be implemented using many single-function components, or can be one component integrated using the technologies described above. The circuits may also be implemented as a specifically programmed general purpose processor, CPU, a specialized microprocessor such as Digital Signal Processor that can be directed by program instructions on a memory, a Field Programmable Gate Array (FPGA) that can be programmed after manufacturing, or a reconfigurable processor. Some or all of the functions may be implemented by such a processor while some or all of the functions may be implemented by circuitry in any of the forms discussed above.

The present invention may be a non-transitory computer-readable recording medium having recorded thereon a program embodying the methods/algorithms discussed above for instructing a processor to perform the methods/algorithms.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory.

The sequence of the steps included in the above described algorithms is exemplary, and algorithms having a sequence other than the above described sequences are contemplated. Moreover, steps, or parts of the algorithm, may be implemented simultaneously or in parallel.

The components of the present invention can be in the form of an STB as in the exemplary embodiments disclosed above, or in other standalone devices, or may be incorporated in a television or other content playing apparatus, or other device, appliance or CPE equipment, and the scope of the present invention is not intended to be limited on such forms.

It is also contemplated that the implementation of the components of the present invention can be done with any newly arising technology that may replace any of the above implementation technologies.

We claim:

1. An electronic device, comprising:
a processor; and
a memory having software stored thereon,
wherein the processor is configured to execute the software to at least cause the electronic device to:
determine if at least one user is in proximity to the electronic device;
automatically determine user preference information over time from multimedia content selected when the at least one user is in proximity to the electronic device;
derive a viewing pattern map of preferred multimedia content based on the user preference information; and
perform a background launch operation of the preferred multimedia content of the at least one user based on the viewing pattern map using credentials of the at least one user for the background launch operation.

2. The electronic device of claim 1, wherein the processor is configured to execute the software to cause the electronic device to determine if the at least one user is in proximity to the electronic device by at least one of presence of a mobile device of the at least one user, voice recognition, or face recognition.

3. The electronic device of claim 1, wherein:
the processor is configured to execute the software to cause the electronic device to generate a user prompt for display on a display device; and
the user prompt is configured to display viewing options for the preferred multimedia content of the at least one user.

4. The electronic device of claim 3, wherein the processor is configured to execute the software to cause the electronic device to perform the background launch operation of a service in connection with the preferred multimedia content of the at least one user in advance of generation of the user prompt using the credentials of the at least one user for the background launch operation.

5. The electronic device of claim 1, wherein:
the at least one user includes a first user and a second user;
the processor is configured to execute the software to cause the electronic device to generate a user prompt for display on a display device when the first user moves out of proximity of the electronic device; and
the user prompt is configured to display viewing options for the preferred multimedia content of the second user.

6. The electronic device of claim 5, wherein the processor is configured to execute the software to cause the electronic device to perform the background launch operation of a service in connection with the preferred multimedia content of the second user in advance of generation of the user prompt using credentials of the second user for the background launch operation.

7. The electronic device of claim 1, wherein the processor is configured to execute the software to cause the electronic device to log the at least one user out of a content provider account when the at least one user moves out of proximity of the electronic device.

8. The electronic device of claim 1, wherein the processor is configured to execute the software to cause the electronic device to record the preferred multimedia content of the at least one user when the at least one user is not in proximity to the electronic device.

9. A method, comprising:
determining if at least one user is in proximity to an electronic device;
automatically determining, by operation of an electronic processor, user preference information associated with the user over time from multimedia content selected when the at least one user is in proximity to the electronic device;
deriving a viewing pattern map of preferred multimedia content based on the user preference information; and
performing a background launch operation of the preferred multimedia content of the at least one user based on the viewing pattern map using credentials of the at least one user for the background launch operation.

10. The method of claim 9, wherein the at least one user is determined to be in proximity to the electronic device by at least one of presence of a mobile device of the at least one user, voice recognition, or face recognition.

11. The method of claim 9, further comprising:
generating a user prompt for display on a display device,
wherein the user prompt is configured to display viewing options for the preferred multimedia content of the at least one user.

12. The method of claim 11, further comprising performing the background launch operation of a service in connection with the preferred multimedia content of the at least one user in advance of generation of the user prompt using the credentials of the at least one user for the background launch operation.

13. The method of claim 9, wherein:
the at least one user includes a first user and a second user;
the method further comprises generating a user prompt for display on a display device when the first user moves out of proximity of the electronic device; and
the user prompt is configured to display viewing options for the preferred multimedia content of the second user.

14. The method of claim 13, further comprising performing the background launch operation of a service in connection with the preferred multimedia content of the second user in advance of generation of the user prompt using credentials of the second user for the background launch operation.

15. The method of claim 9, further comprising logging the at least one user out of a content provider account when the at least one user moves out of proximity of the electronic device.

16. The method of claim 9, further comprising recording the preferred multimedia content of the at least one user when the at least one user is not in proximity to the electronic device.

17. A non-transitory computer readable storage medium having stored thereon a program to be executed by an electronic device, the program causing the electronic device to perform steps comprising:
determining if at least one user is in proximity to an electronic device;
automatically determining, by operation of an electronic processor, user preference information over time from multimedia content selected when the at least one user is in proximity to the electronic device;
deriving a viewing pattern map of preferred multimedia content based on the user preference information; and
performing a background launch operation of the preferred multimedia content of the at least one user based on the viewing pattern map using credentials of the at least one user for the background launch operation.

18. The non-transitory computer readable storage medium of claim 17, wherein the at least one user is determined to be in proximity to the electronic device by at least one of presence of a mobile device of the at least one user, voice recognition, or face recognition.

19. The non-transitory computer readable storage medium of claim 17, wherein the program causes the electronic device to generate a user prompt for display on a display device,
wherein the user prompt is configured to display viewing options for the preferred multimedia content of the at least one user.

20. The non-transitory computer readable storage medium of claim 19, wherein the program causes the electronic device to perform the background launch operation of a service in connection with the preferred multimedia content of the at least one user in advance of generation of the user prompt using the credentials of the at least one user for the background launch operation.
